(19) United States
(12) Patent Application Publication
(10) Pub. No.: US 2009/0172755 A1
(43) Pub. Date: Jul. 2, 2009

(54) METHOD AND SYSTEM FOR MOBILE MEDIA POINT-OF-SALE

(75) Inventor: David Christopher St. John-Larkin, Denver, CO (US)

Correspondence Address: EchoStar Technologies, L.L.C., c/o Dorsey & Whitney LLP, 370 Seventeenth St, Suite 4700, Denver, CO, 80202, US

(73) Assignee: EchoStar Technologies Corporation, Englewood, CO (US)

(21) Appl. No.: 11/967,751

(22) Filed: Dec. 31, 2007

(51) Int. Cl. H04N 7/173

(52) U.S. Cl. 725/100

(57) ABSTRACT

One embodiment may take the form of a method and a system for mobile media point-of-sale (POS). A mobile media-receiving device may receive, via a first network (e.g. a broadcasting network), a media file for playback to a user. The media may include media and media identifying data. Upon receipt of the media file, the media-receiving device may transmit a user-initiated request to purchase a copy of the media from a POS source. The media-receiving device may transmit the request and the media identifying data, using a portable storage device or a wireless network, to a computer-networking device. The computer-networking device may receive the request, the media identifying data, and the user's purchase information and transmit this information, via a second network that is separate and independent from the first network, to a POS source to complete the purchasing transaction of the media file.

### INTRODUCTION

The present invention generally relates to a method and system for point-of-sale. More particular, the present invention relates to a method and system for mobile media point-of-sale.

### BACKGROUND

In general, a point-of-sale (POS) system pertains to a customer-check system that uses automated devices linked to a computer that directly transmits sales data as part of a computerized system accounting and inventory. The POS may be a store, dealer, or other retail outlet where an item is sold. In order to purchase an item, a customer may be limited to purchasing the item at the POS location.

There is a need in the art for a mobile POS system to purchase media.

### SUMMARY

One embodiment may take the form of a method and a system for mobile media point-of-sale (POS). In operation, a broadcasting station or satellite may broadcast a media file via a broadcasting network. The media file may include media and media identifying data. The media may include audio and/or video data. The media identifying data may identify the media by, although not limited to, an artist's name and a title. A mobile media-receiving device, while in transit or in at fixed location, may receive the media file for playing for a user via the broadcasting network.

Upon receipt of the media file, the media-receiving device may transmit a user-initiated request to purchase a copy of the media associated with the media file from a POS source. The request may include, among other things, purchase information of a user. In doing so, the media-receiving device may transmit the request and the media identifying data, using a portable storage device (e.g. a dongle or universal serial bus (USB) device, and so on) or a wireless network (e.g. Bluetooth), to a computer-networking device.

The computer-networking device may receive the media identifying data and the request to purchase the copy of the media. Upon receipt, the computer-networking device may transmit the request and the media identifying data to a POS source to complete the purchasing transaction of the media. This information may be transmitted, over a second network that is separate and independent from the broadcasting network. For example, the second network may be the Internet or any network associated with the computer-networking device.

To complete the purchasing transaction, the POS source may use the purchasing information to bill the user for the purchase of the copy of the media. The purchasing information may include the user's name and account information. After billing the user's account, the POS source may transmit, via the second network, a copy of the media to the computer-networking device. The computer-networking device, in turn, may store the copy of the media in a related data store. Otherwise, the computer-networking device may transmit the copy of the media, via a portable storage device or the wireless network, to the media-receiving device. Once the media is received, the media-receiving device may playback the media.

As will be realized by those of ordinary skill in the art upon reading the entirety of this disclosure, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

The drawings described herein are for illustration purposes only and are not intended to limit the scope of the present disclosure in any way.

FIG. 1 depicts an exemplary environmental view for an exemplary mobile media point-of-sale (POS) system.

FIG. 2 is a block diagram of the exemplary mobile media point-of-sale (POS) system.

FIG. 3 is a block diagram of an exemplary media-receiving device of FIG. 2.

FIG. 4 is a block diagram of an exemplary computer-networking device of FIG. 2.

FIG. 5 is an exemplary flow chart illustrating an operation of the mobile media POS system in FIG. 2.

FIG. 6 is an exemplary flow chart illustrating an operation of the media-receiving device in FIG. 3.

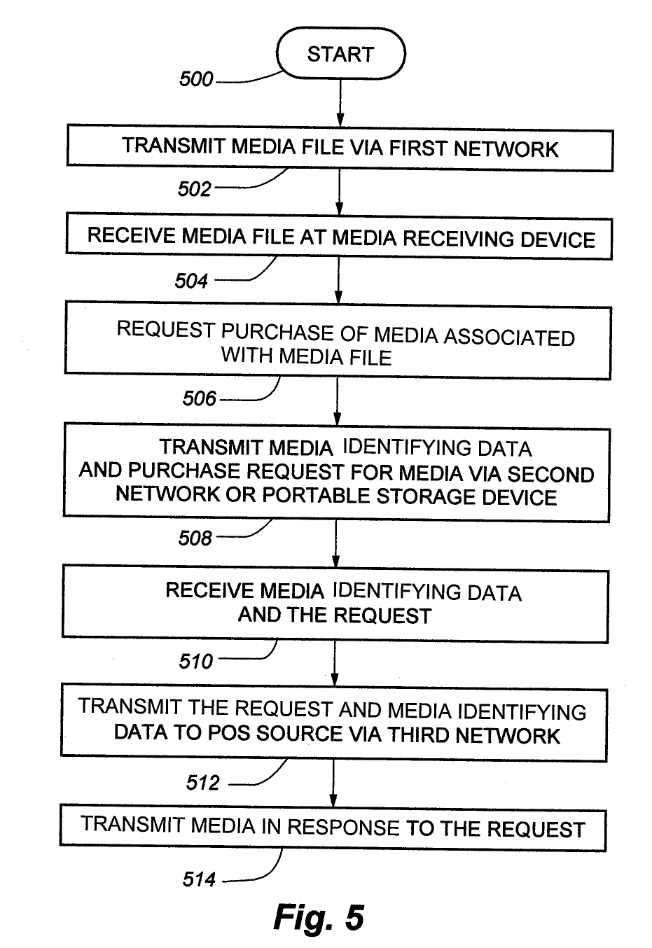

FIG. 5 is an exemplary flow chart illustrating an operation of the computer-networking device in FIG. 4.

### DETAILED DESCRIPTION OF VARIOUS EMBODIMENTS

One embodiment may take the form of a method and a system for mobile media point-of-sale (POS). In operation, a broadcasting station or satellite may broadcast a media file via a broadcasting network. The media file may include media and media identifying data. The media may include audio and/or video data. The media identifying data may identify the media by, although not limited to, an artist's name and a title. A mobile media-receiving device, while in transit or in at fixed location, may receive the media file for playing for a user via the broadcasting network.

Upon receipt of the media file, the media-receiving device may transmit a user-initiated request to purchase a copy of the media associated with the media file from a POS source. In addition to requesting the purchase of media, the request may also include, among other things, a user's name. The request may also include billing account information for the user. The media-receiving device may transmit the request and the media identifying data, using a portable storage device (e.g. a dongle or universal serial bus (USB) device, and so on) or a wireless network (e.g. Bluetooth, etc.), to a computer-networking device.

The computer-networking device may receive the media identifying data and the request to purchase the copy of the media. Upon receipt, the computer-networking device may transmit the request and the media identifying data to a POS source to complete the purchasing transaction of the media. The request and the media identifying data information may be transmitted over a second network that is separate and independent from the broadcasting network, for example, the Internet.

The POS source may use the user's billing account information to bill the user for the purchase of the copy of the media. After billing the user's account, the POS source may transmit, via the second network, a copy of the media to the computer-networking device. The computer-networking device, in turn, may store the copy in a related data store. Otherwise, the computer-networking device may transmit the copy of the media, via the portable storage device or the wireless network, to the media-receiving device. Once the media is received, the media-receiving device may allow a user to initiate a playback of the media.

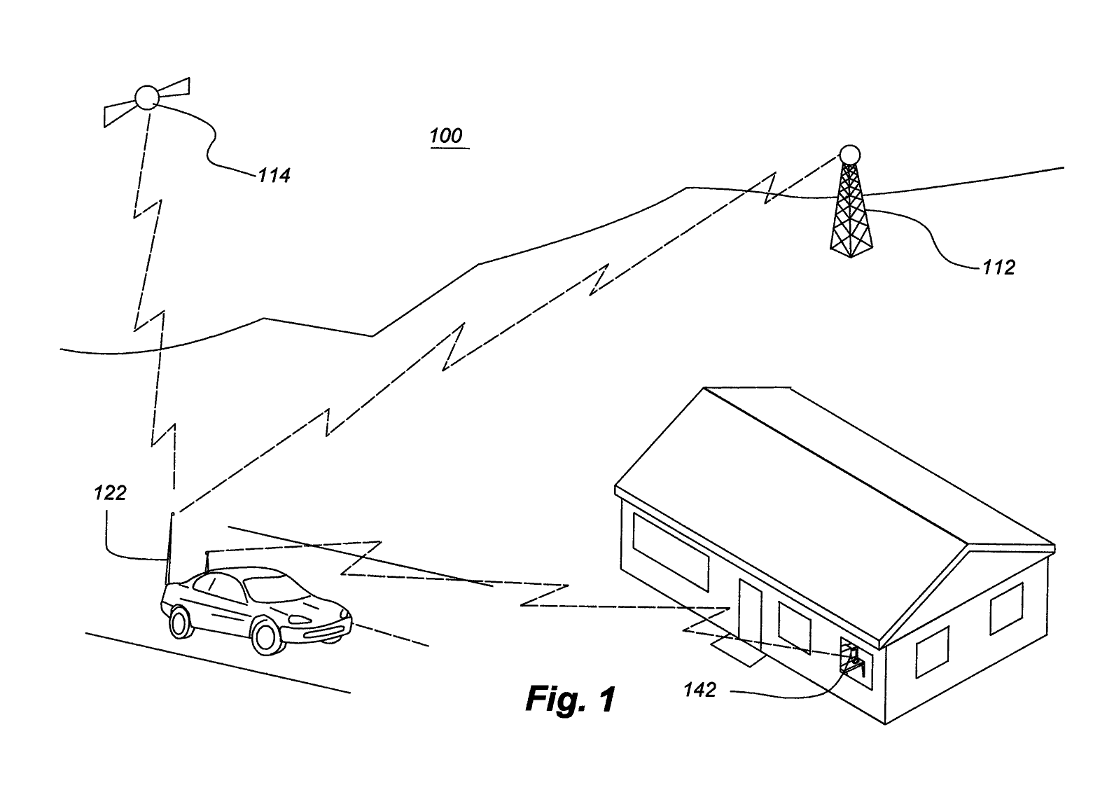

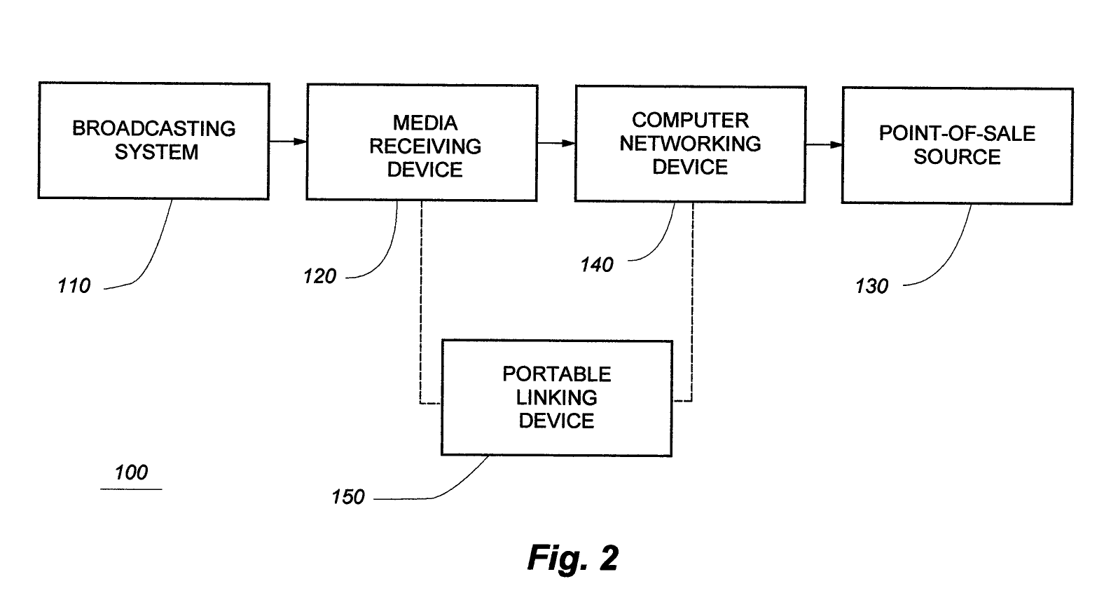

FIG. 1 depicts an exemplary environmental view for an exemplary mobile media point-of-sale (POS) system 100. FIG. 2 is a block diagram of the exemplary mobile media POS system 100.

Referring to FIGS. 1 and 2, the POS system 100 may include a broadcasting system 110, such as a radio and/or television station network 112 and/or a satellite network 114. The broadcasting system 110 may transmit at least one media file, over a first wireless network. The media file may include media data and media identifying data that identifies the media associated with the media file. The media may include video and/or audio data. The media identifying data may include, among other things, an artist's name, title of the media and/or time duration of the media.

Still referring to FIGS. 1 and 2, the POS system 100 may include a media-receiving device 120. The media-receiving device 120 may receive a broadcasted signal having the media file, via the wireless broadcasting network. A media receiving device 120 may, for example, include any conventional set-top box coupled with a display or audio module, cellular phone, or digital radio device 122, and so on. The media-receiving device 120 may have a fixed or mobile location. In other words, the media-receiving device 120 may be portable to be carried in a user's hand. As shown in FIG. 1, for example, the media-receiving device 120 may be located within an automobile or other mobile device or system.

Upon request by a user, the media-receiving device 120 may transmit the media identifying data and a request to purchase media to a POS source 130. Additionally, the media-receiving device 120 may receive, from the POS source 130, a copy of media based on a user-initiated purchase request.

The media-receiving device 120 may include an activation state and a deactivation state. In the activation state, the media-receiving device 120 may receive the broadcasted signals. Additionally, in this state the media-receiving device 120 may control playback, when initiated by the user, received media files, as well as transmit data. In the deactivation state, the media-receiving device 120 may not receive media files.

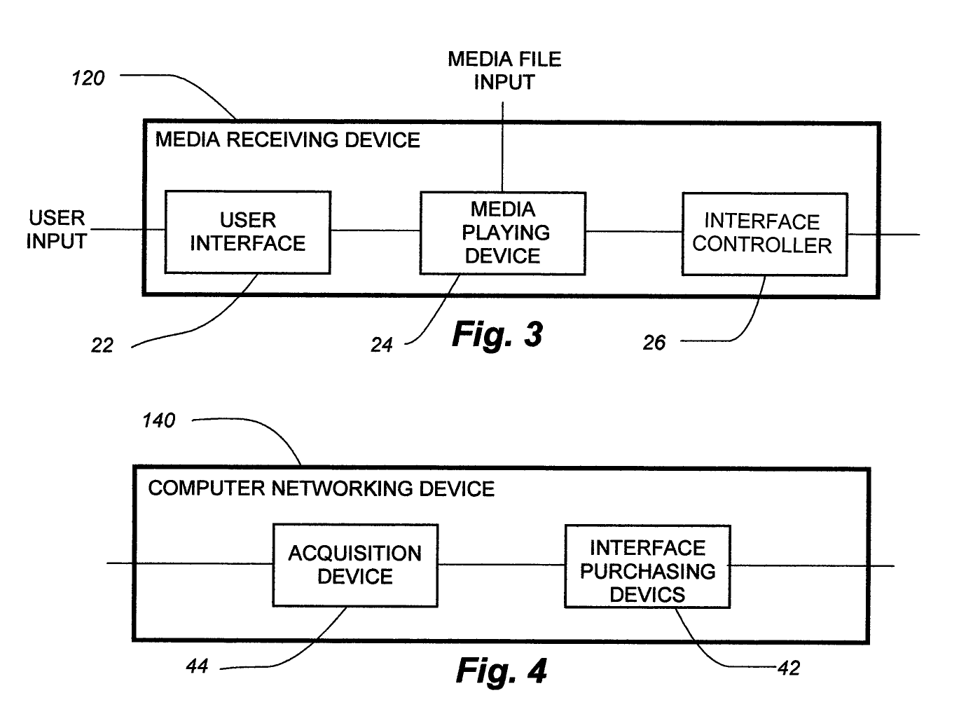

FIG. 3 is a block diagram of an exemplary media-receiving device 120 of FIG. 2.

Referring to FIG. 3, the media-receiving device 120 will now be discussed in more detail. The media-receiving device 120 may include a user interface 22. The user interface 22 may initiate an activation or deactivation of the media-receiving device 120. The user interface 22 may also allow a user to interact with one or more controls to select and/or control a media file. For example, the controls may include a purchase request control, a media retrieval control, a play control, a pause control, a fast-forward control, a rewind control (or reverse control), and so on. The purchase request control may output a request to purchase a media file either currently or previously broadcasted to the media-receiving device. The media retrieval control may initiate retrieval of a media file stored in a storage medium. The play control may initiate playing the media file. The pause control may initiate a temporary stop or rest in actuating regarding the media file. The fast-forward control may initiate a rapid advancement of the media file. The rewind control may initiate a wind back to or toward a beginning of the media file.

The request for purchase of media may include a user's name and billing account information. The user's name may include a first name, a middle initial, and a last name. The billing account information may be used to aid in the acquisition of the copy of the media file. The billing account information may include, among other information, user's name, billing address, and at least one of bank account information, credit card information, and debit card information.

Still referring to FIG. 3, the media-receiving device 120 may include a media-playing device 24. The media-playing device 24 may be in communication with the broadcasting system network and/or the user interface 22. The media-playing device 24 may receive the media file from the broadcasting system network. The media playing device 24 may playback the media file at the election of the user. A monitor (not shown) of the media-playing device 24 may display the media identifying data.

The media-playing device 24 may playback a purchased copy of media stored in a storage medium, such as portable storage device (e.g. flash memory device, USB device, and so on) or a related data store.

Again referring to FIG. 3, the media-receiving device 120 may include an interface controller 26. The interface controller 26 may be in communication with the user interface 22 and/or the media-playing device 24. The interface controller 26 may receive the request, from the user interface 22, to purchase a copy of a media. Upon receipt of the request, the interface controller 26 may request, from the media-playing device 24, the media identifying data. In response thereof, the interface controller 26 may receive the media identifying data from the media-playing device 24.

In one embodiment, the interface controller 26 may store the request in a data store, until it establishes connection with a computer-networking device 140. After establishing connection with the computer-networking device 140, via a second wireless network, the interface controller 26 may transmit the request and the media identifying data to the computer-networking device 140 within the network. The second wireless network may include any conventional wireless network including, but not limited to, mobile telephone networks, Cellular Digital Packet Data networks, High Speed Circuit-Switched Data networks, General Packet Radio Service, 1x Radio Transmission Technology, Bluetooth, Infrared, Local Multipoint Distribution Service, Multichannel Multipoint Distribution Service, Wi-Fi, and any other wireless network that will allow a networking device 140 to receive a transmitted signal from the interface controller 26. Still referring to FIG. 3, in one embodiment, the interface controller 26 may receive purchased media via the wireless network. After receiving the copy, the interface controller 26 may store it in a related data store.

In one embodiment, the interface controller 26 may transmit the request and the media identifying data to a portable storage device 150 (e.g. dongle, flash memory device, and so on). The portable storage device 150 may store the request and the media identifying data, until it is connected to a computer-networking device 140. In an embodiment, the interface controller 26 may retrieve a copy of purchased media from the portable storage device 150. After retrieving the copy, the interface controller 26 may transmit the copy to the media-playing device 24 or a related data store.

Referring to FIGS. 1 and 2, the mobile POS system 100 may include a computer-networking device 140. The computer-networking device 140 may be in communication with the media-receiving device 120, via the portable storage device 150 or the wireless network. The computer-networking device 140 may include any electronic device capable of communicating with a media receiving device 120 and a POS source 130. For example, the computer-networking device 140 may include a user's home or office computer 142, a designated point-of-sale computer (e.g. a kiosk), an Internet server, and so on.

The computer-networking device 140 may receive the request and the media identifying data in order to complete the request to purchase media. The computer-networking device 140 may also download media, once the purchase transaction is complete. After receiving the copy, the computer-networking device 140 may transmit the copy to the portable storage device 150 or, via the wireless network, to the media-receiving device 120. In one embodiment, the portable storage device 150 may communicate with the media-receiving device 120, and transmit the copy to the media-receiving device 120. In another embodiment, the portable storage device 150 may communicate with another electronic device capable of playing media, and transmit the media to the electronic device. In one embodiment, the computer-networking device 140 may transmit the copy to another electronic device, via a third wireless network. This third wireless network may be the same as the second wireless network, or it may be a separate and distinct network from the wireless network that the media-receiving device 120 transmitted the request.

FIG. 4 is a block diagram of an exemplary computer-networking device 140 of FIG. 2.

Referring to FIG. 4, the computer-networking device 140 will now be discussed in more detail. The computer-networking device 140 may include an interface-purchasing device 42. The interface-purchasing device 42 may be in communication with the portable storage device 150, or, alternatively, via the second wireless network, the interface controller 26 of the media-receiving device 120. In one embodiment, the interface purchase device 42 may receive the request and the media identifying data from the media-receiving device 120 either directly or indirectly, such as for example, via the wireless network or the portable storage device 150.

Still referring to FIG. 4, the computer-networking device 140 may include an acquisition device 44. The acquisition device 44 may be in communication with the interface-purchasing device 42. In one embodiment, the acquisition device 44 may receive the request and the media identifying data from the interface-purchasing device 42 to purchase the media.

In one embodiment, as previously stated, the request may include the user's billing account information. In another embodiment, the billing account information may be stored in a data store related to the acquisition device 44. In either case, the acquisition device 44 may receive the purchase information to acquire the requested media.

The acquisition device 44 may establish a connection with the POS source 130. Afterwards, the acquisition device 44 may transmit the request, including the user's purchase information, and the media identifying data to the POS source 130 in order to purchase the requested media. After the transaction is completed, the acquisition device 44 may receive the requested media. At which time, the acquisition device 44 may transmit the requested media to the interface-purchasing device 42.

Referring to FIGS. 1 and 2, the system may include a POS source 130. The POS source 130 may receive the request and the media identifying data from the computer-networking device 140. At which time, the POS source 130 may bill the user's account using the purchase information. After crediting the user's account, the POS source 130 may transmit a copy of the request media to the computer-networking device 140. The POS source 130 may include a customer-checkout system, of a store, dealer, or other retail outlet where media files are sold, that uses automated devices linked to a computer, as a point-of-sale terminal that directly receives requests for purchase of media files along with other purchasing information, verifies the purchase information, credits the user account, and transmits the requested media files to a requesting computer networking device 140. The customer-checkout system may also transmit sales data as part of a computerized system for accounting and inventory control. The POS source 130, for example, may include the store, dealer, or other retail outlet where the media is sold.

When the purchase of the media is complete, the POS source 130 may output a message to the computer-networking device 140 indicating a successful purchase of media. Likewise, the POS source 130 may output the message to an email address of the user. On the other hand, in the event that the POS source 130 determines that the purchase information is invalid, the POS source 130 may terminate the requested transaction. The POS source 130 may transmit an incomplete transaction message to the computer-networking device 140. The incomplete transaction message may be a brief generic description stating that the transaction was incomplete or a very detailed and/or specific message explaining why the transaction was incomplete. Alternatively, the POS source 130 may output a message to the email address of the user. If the media identifying data does not equal media sold by the POS source 130, the POS source 130 may transmit an incomplete transaction message. This incomplete transaction message may be the same as the incomplete transaction message for the invalid purchase information, or it may be a different message.

In one embodiment, the media-receiving device 120 may communicate directly with the POS source 130 via a wireless network. The wireless network may be separate and distinct from the broadcasting network used by the media-receiving device 120 to receive the broadcasted media file. In doing so, the media-receiving-device 120 may transmit requests and/or received requested media directly from the POS device 130 with or without the aid of the computer-networking device 140.

In another embodiment, the portable storage device 150 may communicate with the POS source 130. When connected to the POS source 130, the portable storage device 150 may transmit the request and the media identifying data to the POS source 130. In turn, the POS source 130 may transmit a copy of the requested media to the portable storage device 150. The portable storage device 150 may transmit the copy to any electronic device, including the media-receiving device 120, capable of storing and/or playing the media.

FIG. 5 is a first exemplary flow chart illustrating an operation of the mobile media POS system in FIG. 2.

The sequence begins at start operation 500. In operation 502, a broadcasting network system transmits, via a radio broadcasting network or a satellite link, at least one media file. The media file may include media and media identifying data. A media-playing device of a media-receiving device receives the media file in operation 504. In operation 506, a user interface of the media-receiving device transmits a user initiated purchase request of media related to the media file. The purchase request may include a request to purchase media and purchase information of a user. An interface controller, in communication with the user interface, receives the purchase request. The interface controller, in communication with the media-playing device, requests the media identifying data of the media file. In response, the media-playing device transmits the media identifying data to the interface controller. The interface controller receives the media identifying data, and, in operation 508, transmits the media identifying data and the purchase request to a computer-networking device via a portable storage device or a wireless network. In operation 510, an interface-purchasing device, in communication with the computer-networking device, receives the request and the media identifying data. The interface-purchasing device, in turn, transmits the request and the media identifying data to an acquisition device. In operation 512, the acquisition device transmits, via another network, the request and the media identifying data to a POS source. This network is a separate and distinct network from the broadcasting network used by the media-receiving device to receive the media file. The POS source receives the request and the media identifying data. The POS source identifies the user, using the purchasing information of the request, and bills the user the cost of the media. At which time, the POS transmits the media to the acquisition device of the computer-networking device in operation 516. The acquisition device, in turn, transmits the media to the media-receiving device, via the wireless network, or the portable storage device.

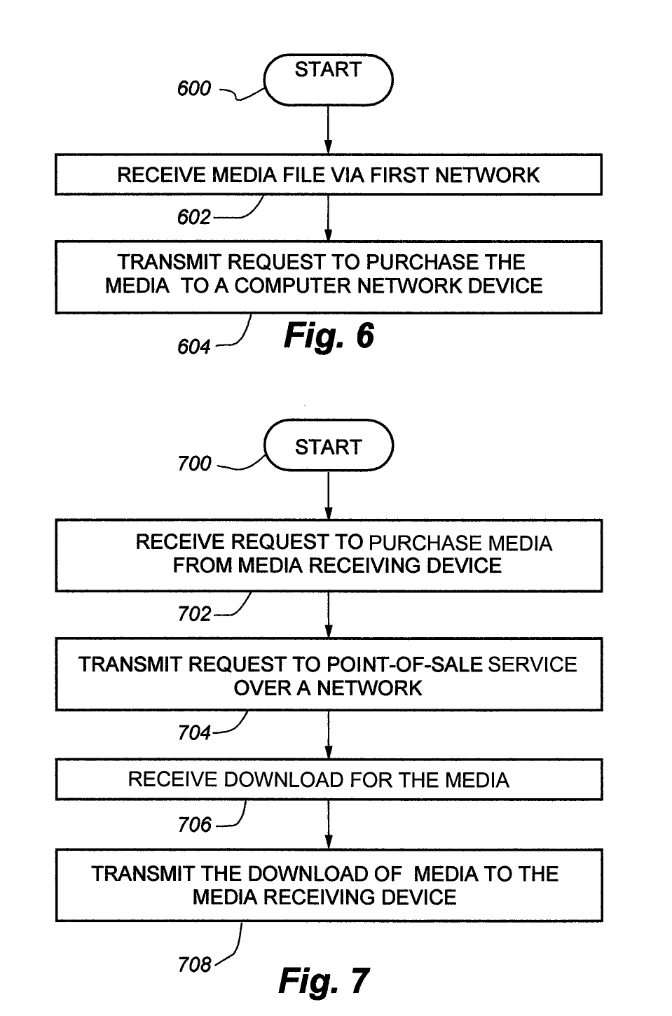

FIG. 6 is an exemplary flow chart illustrating an operation of the media-receiving device in FIG. 3. The sequence begins at start operation 600. In operation 602, the media-receiving device may receive a media file, for example, via a first network. In operation 604, the media-receiving device may transmit a request to purchase the media to a computer-networking device.

FIG. 5 is an exemplary flow chart illustrating an operation of the computer-networking device in FIG. 4. The sequence begins at start operation 700. In operation 702, the computer-networking device may receive the request to purchase a media from a media-receiving device. In operation 704, the computer-networking device may transmit the request to a POS source. In operation 706, the computer-networking device may receive a download of the media. In operation 708, the computer-networking device may transmit the download of the media to the media-receiving device.

Although the present invention has been described with reference to preferred embodiments, persons skilled in the art may recognize that changes may be made in form and detail without departing from the spirit and scope of the invention.

What is claimed is:

1. A media-receiving device comprising:
a media-playing device adapted to receive a media file, over a first network link;
a user interface in communication with the media-playing device and configured to output a user initiated request to purchase a copy of media associated with the media file; and
an interface controller in communication with the user interface and the media-playing device, the interface controller configured to transmit the request over a second network that is separate and independent from the first network.

2. The media-receiving device of claim 1, wherein the media file includes media identifying data to identify the media associated with the media file.

3. The media-receiving device of claim 1, wherein the request includes purchase information of a user to purchase the copy of the media.

4. The media receiving device of claim 3, wherein the purchase information includes at least one of credit card information, bank account information, and debit card information.

5. The media receiving device of claim 1, further comprising a portable storage device in communication with the interface controller, and configured to receive the request and the media identifying data to transmit to a computer networking device.

6. The media receiving device of claim 5, wherein the portable storage device is detachable from the interface controller.

7. The media receiving device of claim 1, wherein the interface controller transmits, to a computer-networking device, the request to purchase the copy of the media file.

8. The media receiving device of claim 1, wherein the media playing device is operably coupled to an automobile.

9. The media receiving device of claim 1, wherein the media-playing device includes at least one of a radio, cell phone, and a set-top box.

10. An electronic device comprising:
an interface purchasing device configured to receive media identifying data associate with media and a request to purchase the media; and
an acquisition device in communication with the interface purchasing device and configured to transmit the media identifying data and the request to purchase the media, via a network link, to a point-of-sale source.

11. The computer device of claim 10, wherein the acquisition device is further configured to receive a download of the media in response to the request being transmitted to the point-of-sale source.

12. The computer device of claim 11, wherein the acquisition device is further configured to transmit the media to a portable storage device.

13. The computer device of claim 11, wherein the acquisition device is further configured to transmit the media, via a different network link, to a media-receiving device.

14. The computer device of claim 10, wherein the media identifying data comprises an artist's name associated with the media.

15. The computer device of claim 10, wherein the media identifying data comprises a title associated with the media.

16. The computer device of claim 10, wherein the media comprises at least one of video data, audio data, and picture data.

17. A method for purchasing a media file, comprising:
receiving media via a first network;
initiating a request to purchase the media; and
transmitting the request, to a point-of-sale source, to purchase media file via a second network that is separate and distinct from the first network.

18. The method for purchasing the media file of claim 17, further comprising receiving the media from the point-of-sale source.

19. The method for purchasing the media file of claim 17, wherein operation of transmitting the request comprises transmitting the request to a computer-networking device that communicates with the point-of-sale source.

20. The method for purchasing the media file of claim 17, wherein the operation of transmitting the request comprises transmitting the request to a portable storage device that communicates with the point-of-sale source, via a wireless network or a computer-networking device.
